(19) United States
(12) Patent Application Publication
(10) Pub. No.: US 2026/0120654 A1
(43) Pub. Date: Apr. 30, 2026

(54) ELECTRONIC PAPER DISPLAY DEVICE AND DRIVING METHOD THEREOF

(71) Applicant: E Ink Holdings Inc., Hsinchu (TW)

(72) Inventors: Chi-Liang Wu, Hsinchu (TW); Wei-Tsung Chen, Hsinchu (TW); Chia-Hao Kuo, Hsinchu (TW); Xue-Hung Tsai, Hsinchu (TW)

(73) Assignee: E Ink Holdings Inc., Hsinchu (TW)

(21) Appl. No.: 19/365,186

(22) Filed: Oct. 22, 2025

Related U.S. Application Data
(60) Provisional application No. 63/711,705, filed on Oct. 25, 2024.

(51) Int. Cl. G09G 3/34

(52) U.S. Cl. CPC G09G 3/344; G09G 2310/0267; G09G 2310/08; G09G 2320/0247

(57) ABSTRACT

An electronic paper display (EPD) device and a driving method thereof are provided. The electronic paper display device comprises an electronic paper display panel and a gate driver on array (GOA), where the EPD panel and the GOA of the EPD device are disposed on an EPD substrate. The EPD panel includes N scan lines. The driving method includes following steps. An interlaced scan across K scan lines for the N scan lines are performed based on controlling the gate driver on array.

### CROSS-REFERENCE TO RELATED APPLICATION

This application claims the priority benefit of U.S. provisional application Ser. No. 63/711,705, filed on Oct. 25, 2024. The entirety of the above-mentioned patent application is hereby incorporated by reference herein and made a part of this specification.

### BACKGROUND

### Technical Field

The disclosure relates to a technology of an electronic paper display (EPD), and in particular to an electronic paper display device and a driving method thereof.

### Related Art

An electronic paper display may utilize incident light (such as sunlight and indoor ambient light) to illuminate an electronic ink layer to display a frame, and therefore does not require a backlight source. Moreover, the electronic paper display only needs to scan and update data of the display panel when frames are switched, and does not need to consume power to maintain the frames like liquid crystal displays or light-emitting diode displays, thus resulting in significant power savings.

In a case where an electronic paper display switches frames, since scanning and updating the display panel adopts a progressive scan manner, users may experience a strong flicker sensation. Therefore, how to reduce the flicker sensation of an electronic paper display when switching frames is an important area of research.

### SUMMARY

The disclosure provides an electronic paper display device and a driving method thereof, which may reduce the flicker of an electronic paper display when frames are switched.

A driving method of an electronic paper display device of the disclosure are provided. The electronic paper display device comprises an electronic paper display panel and a gate driver on array, wherein the electronic paper display panel and the gate driver on array of the electronic paper display device are disposed on an electronic paper display substrate, the electronic paper display panel comprises N scan lines, and the N is a positive integer and an even number. The driving method includes following steps: based on controlling the gate driver on array, performing an interlaced scan across K scan lines for the N scan lines on the electronic paper display panel. The step of the interlaced scan across the K scan lines includes scanning an Xth scan line, and scanning an (X+K)th scan line, where the X is a positive integer sequentially increasing, and 1≤X≤N.

An electronic paper display device of the disclosure includes an electronic paper display panel, a display controller, and a gate driver on array. The electronic paper display panel includes N scan lines. The gate driver on array is coupled to the display controller and the electronic paper display panel. The electronic paper display panel and the gate driver on array are disposed on an electronic paper display substrate. The display controller controls the gate driver on array to perform an interlaced scan across K scan lines on the electronic paper display panel, where K is a positive integer less than N.

Based on the above, the embodiments of the disclosure perform frame scan and update on the electronic paper display through interlaced scan across a fixed number of scan lines, and the number of scan lines across by this interlaced scan may be adjusted according to the requirements. For example, the interlaced scan may be performed with the gap of approximately one-fourth of the scan lines of the display panel. If the display panel has 1440 scan lines, the interlaced scan may be performed with the gap of 360 scan lines or 1080 scan lines. In the embodiments of the disclosure, the gate driver on array circuit structure is used to implement the aforementioned interlaced scan, which may reduce the flicker of the electronic paper display when frames are switched.

### BRIEF DESCRIPTION OF THE DRAWINGS

FIG. 1 is a schematic diagram of an electronic paper display device according to an embodiment of the disclosure.

FIG. 2 is a schematic diagram illustrating an interlaced scan across multiple scan lines according to an embodiment of the disclosure.

FIG. 3 is a flowchart illustrating a driving method of an electronic paper display device according to an embodiment of the disclosure.

FIG. 4 is a schematic diagram illustrating a detailed structure of a gate driver on array according to a first embodiment of the disclosure.

FIG. 5A and FIG. 5B are timing diagrams of enable signals, voltage control clock signals, and reset signals in FIG. 4.

FIG. 6 is a schematic diagram illustrating a detailed structure of a gate driver on array according to a second embodiment of the disclosure.

FIG. 7 is a schematic diagram illustrating a detailed structure of a gate driver on array according to a third embodiment of the disclosure.

### DESCRIPTION OF THE EMBODIMENTS

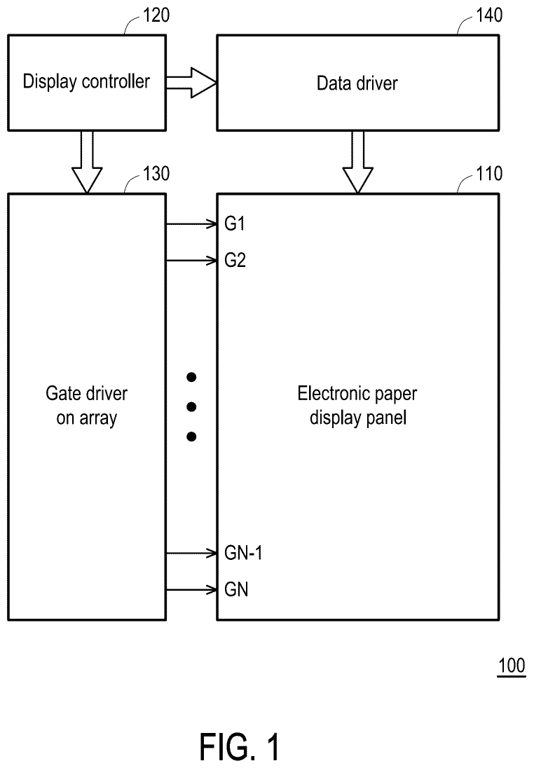

FIG. 1 is a schematic diagram of an electronic paper display device according to an embodiment of the disclosure. An electronic paper display (EPD) device 100 mainly includes an electronic paper display (EPD) panel 110, a display controller 120, and a gate driver on array (GOA) 130. The EPD device 100 further includes a data driver 140.

The EPD panel 110 includes N scan lines G1 to GN. Nis a positive integer and an even number. In this embodiment, a resolution of the EPD panel 110 is exemplified as 1920×1440. That is, the EPD panel 110 has 1440 scan lines (i.e., N is 1440), and each of the scan lines has 1920 pixel units. The display controller 120 is, for example, a timing controller and is configured to control the GOA driver 130 and the data driver 140 to refresh display data of the EPD panel 110 by scanning the scan lines G1 to GN. The display controller 120 may control the GOA driver 130 and the data driver 140 by providing signals such as a voltage control clock signal VCK, a vertical synchronization signal CST, and a reset signal RST.

The GOA driver 130 and the EPD panel 110 of this embodiment are disposed on the same EPD substrate. In other words, a distance disposed between the GOA driver 130 and the EPD panel 110 is relatively close, so that the GOA driver 130 may rapidly enable corresponding scan lines G1 to GN, and the data driver 140 may rapidly provide data on one of the enabled scan lines G1 to GN to multiple pixel units on one of the enabled scan lines G1 to GN.

The display controller 120 controls the GOA driver 130 to perform an interlaced scan across K scan lines on the EPD panel 110. K is less than N and is a positive integer. In this embodiment, a value of K may be determined by persons implementing this embodiment according to the requirements, and K is not 0. Assuming N is 1440, a number of across K scan lines may be 360 (i.e., N/4, a gap of one-fourth of the scan lines on the panel), 480 (i.e., N/3, a gap of one-third of the scan lines on the panel), or 1080 (i.e., 3N/4, a gap of three-fourths of the scan lines on the panel).

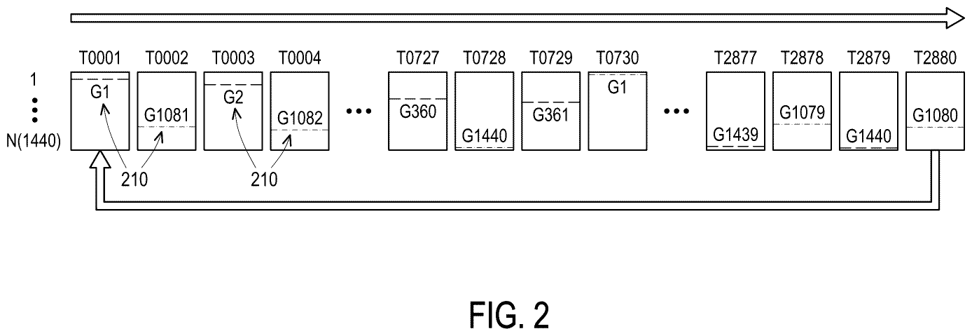

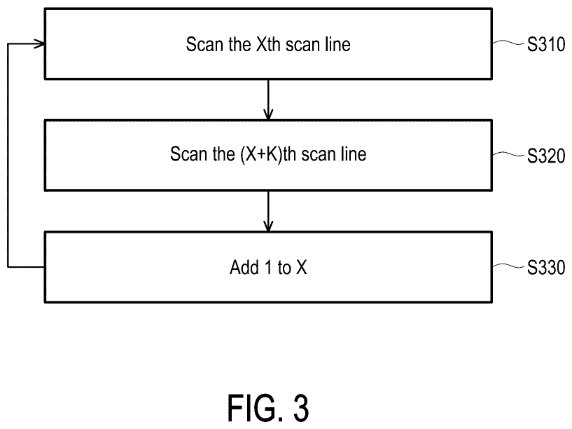

FIG. 2 is a schematic diagram illustrating an interlaced scan across multiple scan lines according to an embodiment of the disclosure. FIG. 3 is a flowchart illustrating a driving method of an electronic paper display device according to an embodiment of the disclosure. For convenience of describing this embodiment, “interlaced scan across K scan lines” is abbreviated as “across interlaced scan” herein. The EPD panel 110 with the resolution of 1920×1440 is taken as an example in FIG. 2. The EPD panel 110 has 1440 scan lines G1 to GN. Here, the gap of three-fourths of the scan lines on the panel (i.e., K is 1080) is taken as an example to describe the details of “across interlaced scan”.

In FIG. 2, the interlaced scan divides time for scanning a frame of the EPD panel 110 into 2880 (i.e., 2N) scan time periods T0001 to T2880. That is, the scan time of the frame is divided into 2880 scan steps.

Please refer to FIG. 2 and FIG. 3 together. In step S310, the display controller 120 controls the GOA driver 130 to scan the 1st scan line G1 (i.e., X is 1) in the scan time period T0001. In step S320, the display controller 120 controls the GOA driver 130 to scan the 1081st scan line G1081 (i.e., the (X+K)th scan line, where X is 1, and K is 1080) in the scan time period T0002 (i.e., after scanning the 1st scan line). The scan line G1 in the scan time period T0001 and the scan line G1081 in the scan time period T0002 are spaced 1080 (K) scan lines (as shown by a mark 210) apart.

In step S330, the display controller 120 adds 1 to X in the scan time period T0003 (i.e., after scanning the 1081st scan line G1081). Returning to step S310, the display controller 120 controls the GOA driver 130 to scan the 2nd scan line G2 (i.e., the Xth scan line, where X is 2). By analogy, the “across interlaced scan” described in the driving method of the EPD device may be implemented. For example, in the scan time period T0004 (i.e., after scanning the 2nd scan line G2), the display controller 120 controls the GOA driver 130 to scan the 1082nd scan line G1082 (i.e., the (X+K)th scan line, where X is 2, and K is 1080). The scan line G2 in the scan time period T0003 and the scan line G1082 in the scan time period T0004 are spaced 1080 (K) scan lines (as shown by the mark 210) apart.

It is particularly noted that when (X+K) is greater than N, scanning the (X+K)th scan line is changed to scanning the (X+K−N)th scan line, and when (X+1) is greater than N, scanning the (X+1)th scan line is changed to scanning the (X+1−N)th scan line. For example, in the scan time period T0729, the 361st scan line G361 is scanned (i.e., the Xth scan line, where X is 361). In the scan time period T0730, the 1441st scan line should originally be scanned ((X+K) equals 1441), but since the EPD panel 110 only has 1440 scan lines G1 to G1440, it is changed to scan the 1st scan line G1 ((X+K−N) equals 1).

In the scan time period T2879, the 1440th scan line G1440 is scanned (that is, scanning the Xth scan line, where X is 1440). In the scan time period T2880, the display controller 120 controls the GOA driver 130 to scan the 1080th scan line G1080 (i.e., scanning the (X+K−N)th scan line, where X is 1440, and K is 1080). Next, if the frame is to be continuously updated, the display controller 120 returns X from 1440 to 1, and returns from the scan time period T2880 to the scan time period T0001, so as to continue cyclically performing “across interlaced scan” when starting from the scan time period T0001 in FIG. 2.

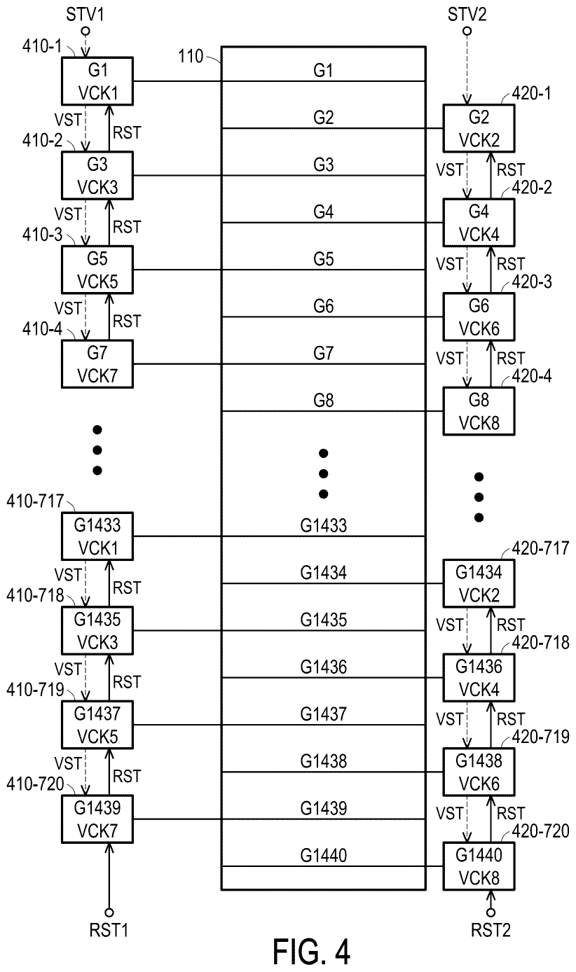

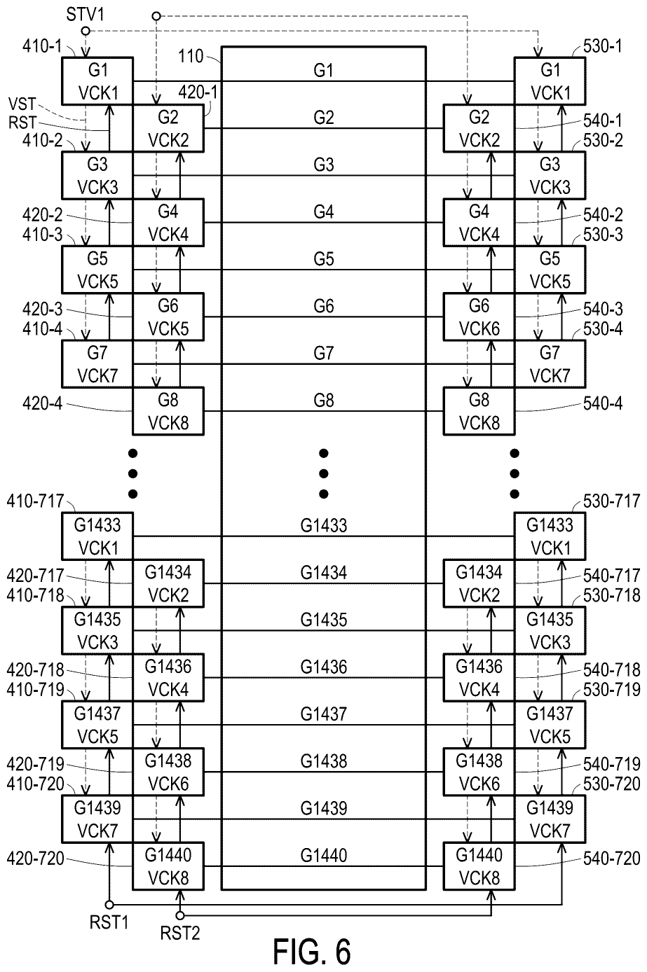

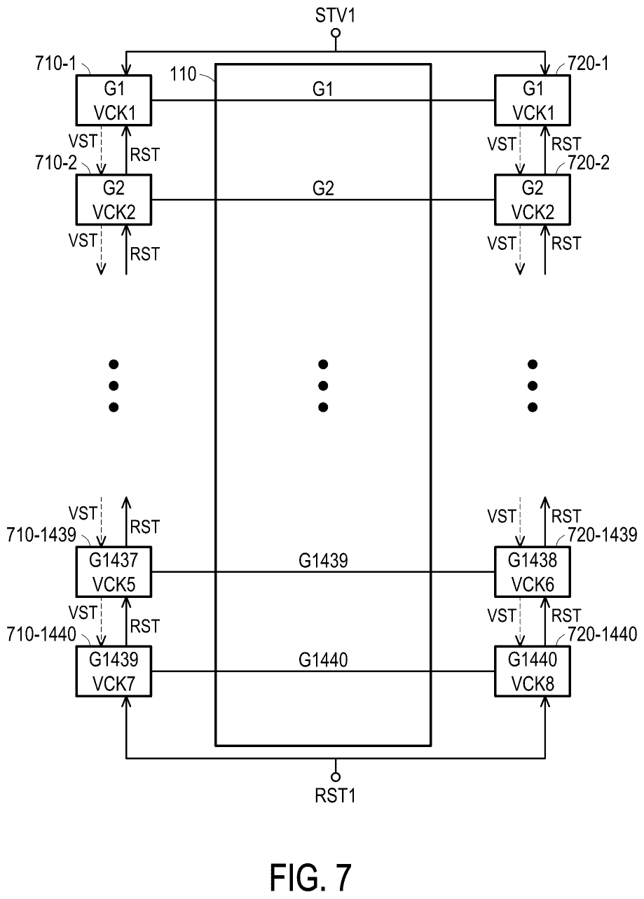

The GOA driver of the embodiments of the disclosure may be implemented by various circuit structures to enhance driving performance. The circuit structures of FIG. 4, FIG. 6, and FIG. 7 are used as examples for description.

FIG. 4 is a schematic diagram illustrating a detailed structure of a gate driver on array according to a first embodiment of the disclosure. The EPD panel 110 with the resolution of 1920×1440 is taken as an example in FIG. 4. The GOA driver 130 in FIG. 2 may include 720 (i.e., N/2) first gate selection circuits 410-1 to 410-720 and 720 (i.e., N/2) second gate selection circuits 420-1 to 420-720 in FIG. 4. The first gate selection circuits 410-1 to 410-720 and the second gate selection circuits 420-1 to 420-720 may respectively be gate driver on array stage (GOA stage) circuits.

A structure of the GOA driver circuit shown in FIG. 4 may be referred to as a single-side input gate driver on array circuit architecture, where each of the scan lines G1 to G1440 is respectively driven by a single gate selection circuit, such as one of the first gate selection circuits 410-1 to 410-720 or the second gate selection circuits 420-1 to 420-720.

In detail, the first gate selection circuits 410-1 to 410-720 are disposed on a first side of the EPD panel 110 (for example, the left side in FIG. 4). Each of the first gate selection circuits 410-1 to 410-720 is respectively coupled to one of the odd-numbered scan lines among the 1440 scan lines. For example, the first gate selection circuit 410-1 is coupled to the scan line G1, the first gate selection circuit 410-2 is coupled to the scan line G3, the first gate selection circuit 410-3 is coupled to the scan line G5, and so on. The first gate selection circuits 410-1 to 410-720 are controlled by an enable signal STV1, voltage control clock signals VCK1, VCK3, VCK5, VCK7, and a reset signal RST1.

The first gate selection circuit (such as the first gate selection circuit 410-1) in a previous stage may provide a signal VST to the first gate selection circuit (such as the first gate selection circuit 410-2) in a next stage to be disposed as a set trigger, so that the first gate selection circuit (such as the first gate selection circuit 410-2) in the next stage may scan the corresponding scan line G3 due to the corresponding voltage control clock signal (such as the voltage control clock signal VCK3). The first gate selection circuit (such as the first gate selection circuit 410-2) in the next stage may provide a signal RST to the first gate selection circuit (such as the first gate selection circuit 410-1) in the previous stage to be disposed as a reset trigger, so that the first gate selection circuit (such as the first gate selection circuit 410-1) in the previous stage may not scan the corresponding scan line G1 due to the corresponding voltage control clock signal (such as the voltage control clock signal VCK1). Therefore, the embodiments of the disclosure may selectively and sequentially scan the odd-numbered scan lines by adjusting the enable signal STV1, the voltage control clock signals VCK1, VCK3, VCK5, VCK7, and the reset signal RST1.

For example, in a case where a certain gate selection circuit 410-N (such as the first gate selection circuit 410-3) is disposed as a set trigger, if the gate selection circuit 410-N (such as the first gate selection circuit 410-3) receives the corresponding and enabled voltage control clock signal (such as the voltage control clock signal VCK5 corresponding to the first gate selection circuit 410-3 being enabled), the corresponding scan line G5 is scanned. In contrast, when a certain gate selection circuit 410-N (such as the first gate selection circuit 410-719) is disposed as a reset trigger, the gate selection circuit 410-N (such as the first gate selection circuit 410-719) may not scan the corresponding scan line G1437 regardless of whether the voltage control clock signal VCK5 is enabled or not.

The second gate selection circuits 420-1 to 420-720 are disposed on a second side of the EPD panel 110 (for example, the right side of FIG. 4). Each of the second gate selection circuits 420-1 to 420-720 is respectively coupled to one of the even-numbered scan lines among the 1440 scan lines. For example, the second gate selection circuit 420-1 is coupled to the scan line G2, the second gate selection circuit 420-2 is coupled to the scan line G4, and the first gate selection circuit 420-3 is coupled to the scan line G6, and so on. The second gate selection circuits 420-1 to 420-720 are controlled by an enable signal STV2, voltage control clock signals VCK2, VCK4, VCK6, VCK8, and a reset signal RST2. Similar to the control mechanism of the first gate selection circuits 410-1 to 410-720, the embodiments of the disclosure may selectively and sequentially scan the even-numbered scan lines by adjusting the enable signal STV2, the voltage control clock signals VCK1, VCK3, VCK5, VCK7, and the reset signal RST2.

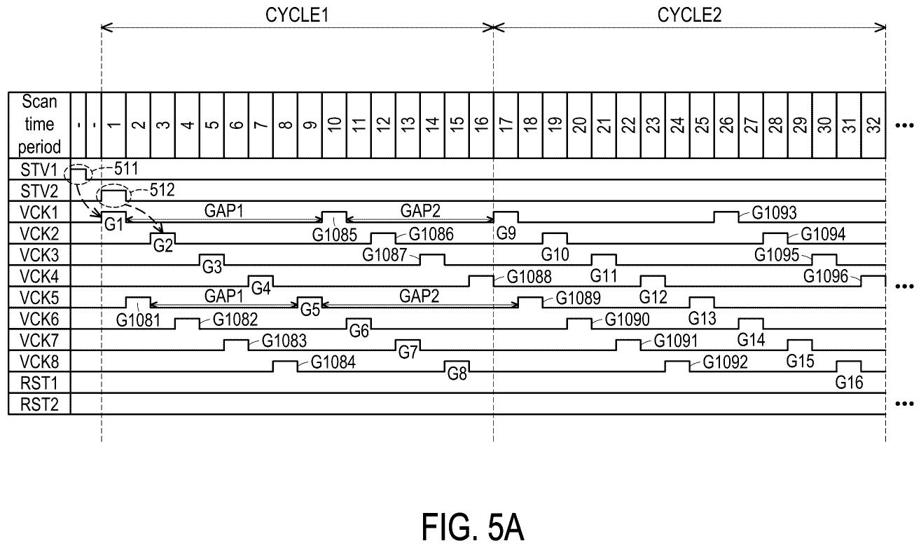

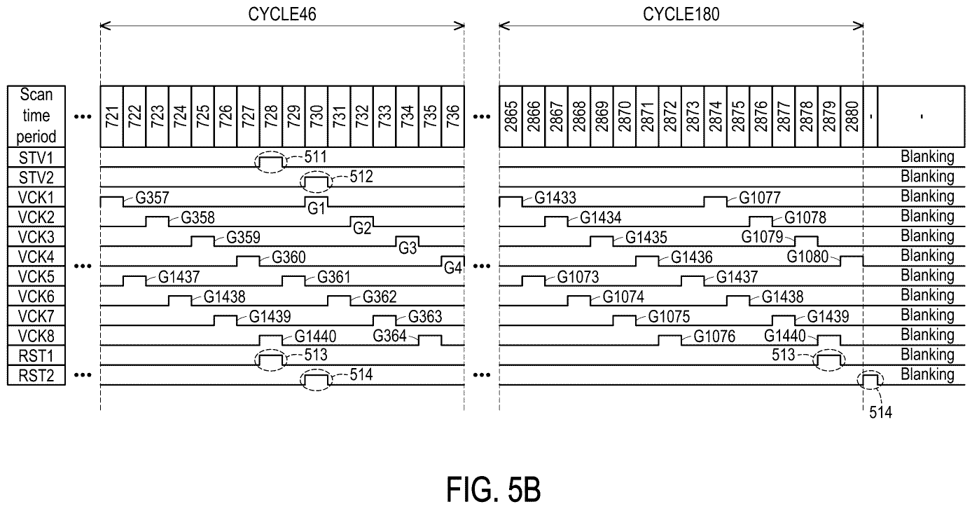

FIG. 5A and FIG. 5B are signal timing diagrams of the enable signal STV1, the voltage control clock signals VCK1 to VCK8, and the reset signal RST1 in FIG. 4. Please refer to FIG. 4 and FIG. 5A together. When the frame of the EPD panel 110 is scanned, the enable signal STV1 is enabled in advance (a mark 511), and the first gate selection circuit 410-1 is thus disposed as a set trigger.

The GOA driver of this embodiment is controlled by P voltage control clock signals (such as the voltage control clock signals VCK1 to CVK8). The time for scanning the frame of the EPD panel 110 is divided into 2880 (i.e., 2N) scan time periods T0001 to T2880, respectively corresponding to the scan time periods 1 to 2880 of FIG. 5A to FIG. 5B. Moreover, the time for scanning the frame of the EPD panel 110 is divided into (2N/2P) cycles. Each cycle has 2P scan time periods. For example, in FIG. 5A to FIG. 5B, the time for scanning the frame of the EPD panel 110 is divided into 180 cycles CYCLE1 to CYCLE180. Each of the cycles CYCLE1 to CYCLE180 has 16 (2*8) scan time periods respectively.

In the same cycle, each of the voltage control clock signals VCK1 to CVK8 is enabled Z times (Z is a positive integer). One time of each of the voltage control clock signals VCK1 to CVK8 being enabled is located in one of odd-numbered scan time periods, and another time of each of the voltage control clock signals VCK1 to CVK8 being enabled is located in one of even-numbered scan time periods. In this embodiment, Z is set as 2. For example, taking the cycle CYCLE1 in FIG. 5A as an example, one time of the voltage control clock signal VCK1 being enabled is located in the 1st scan time period, and another time of the voltage control clock signal VCK1 being enabled is located in the 10th scan time period; one time of the voltage control clock signal VCK2 being enabled is located in the 3rd scan time period, and another time of the voltage control clock signal VCK2 being enabled is located in the 12th scan time period.

In a scan time period 1 of the cycle CYCLE1, the voltage control clock signal VCK1 is enabled, causing the first gate selection circuit 410-1 disposed as a set trigger to scan the corresponding scan line G1. Moreover, the first gate selection circuit 410-1 provides the signal VST to the first gate selection circuit 410-2 in the next stage to be disposed as a set trigger. Afterwards, the first gate selection circuit 410-2 in the next stage provides the signal RST to the first gate selection circuit 410-1 in the previous stage to be disposed as a reset trigger. The first gate selection circuit 410-1 further provides the signal VST to the first gate selection circuit 410-541 (not shown) to be disposed as a set trigger. Moreover, in the scan time period 1, the enable signal STV2 is enabled (a mark 512), and the second gate selection circuit 420-1 is thus disposed as a set trigger.

In a scan time period 2, the voltage control clock signal VCK5 is enabled, causing the first gate selection circuit 410-541 (not shown) to scan the corresponding scan line G1081. Afterwards, the first gate selection circuit 410-542 in the next stage is disposed as a set trigger, and the first gate selection circuit 410-541 (not shown) is disposed as a reset trigger after completing scanning the scan line G1081.

In a scan time period 3, the voltage control clock signal VCK2 is enabled, causing the second gate selection circuit 420-1 to scan the corresponding scan line G2. Afterwards, the second gate selection circuit 420-2 in the next stage is disposed as a set trigger, and the second gate selection circuit 420-1 is disposed as a reset trigger after completing scanning the scan line G1081. The second gate selection circuit 420-1 further provides the signal VST to the second gate selection circuit 410-541 (not shown) to be disposed as a set trigger.

In a scan time period 4, the voltage control clock signal VCK6 is enabled, causing the second gate selection circuit 420-541 (not shown) to scan the corresponding scan line G1082. Afterwards, the second gate selection circuit 420-542 (not shown) in the next stage is disposed as a set trigger, and the second gate selection circuit 420-541 is disposed as a reset trigger after completing scanning the scan line G1081.

By analogy, please refer to FIG. 4 and FIG. 5B together. In a scan time period 728 of the cycle CYCLE46, the scan line G1440 has been scanned, and the scan line G1 is about to be scanned again in scan time period 730. Therefore, while the scan line G1440 is scanned, the reset signal RST1 (a mark 513) corresponding to the enable signal STV1 is also enabled. Moreover, in the scan time period 728, the enable signal STV1 is enabled (the mark 511), and the first gate selection circuit 410-1 is thus disposed as a set trigger.

In a scan time period 730 of the cycle CYCLE46, the reset signal RST2 corresponding to the enable signal STV2 is enabled (a mark 514), the enable signal STV2 is enabled (the mark 511), and the second gate selection circuit 420-1 is thus disposed as a set trigger.

In a scan time period 2895 of the cycle CYCLE181 in FIG. 5B, since this frame is about to complete scanning, the reset signal RST1 (the mark 513) is also enabled while the scan line G1440 is scanned. Moreover, in Blanking after the cycle CYCLE181 in FIG. 5B, the reset signal RST2 is enabled (the mark 514).

Here, P represents a number of voltage control clock signals VCK1 to VCKP, Z represents times that each of the voltage control clock signals VCK1 to VCK8 is enabled in each cycle, and M represents a number of scan time periods that each of the cycles (such as the cycles CYCLE1 to CYCLE2 in FIG. 5A) has. When a frame is scanned, there are 2N/M cycles. There are 8 voltage control clock signals VCK1 to VCK8 (i.e., P is 8) in the aforementioned embodiments. Each of the cycles (such as the cycles CYCLE1 to CYCLE2 in FIG. 5A) has 16 scan time periods (i.e., M is 16). In one cycle (for example, taking the cycle CYCLE1 in FIG. 5A as an example), each of the voltage control clock signals VCK1 to VCK8 is enabled Z times (Z is 2 in this embodiment).

Persons applying this embodiment may adjust P (the number of voltage control clock signals) according to the requirements, and thus change the number of scan time periods in each cycle, as exemplified in Table (1):

TABLE 1

| | | M (number of scan time |
|---|---|---|
| P (number of VCK) | Z (enable times of VCK) | periods in each cycle) |
| 4 | 2 | 8 |
| 6 | 2 | 12 |
| 8 | 2 | 16 |
| 16 | 2 | 32 |

Referring to FIG. 5A, in a cycle (for example, taking the cycle CYCLE1 in FIG. 5A as an example), the gap between enable signals in each of the voltage control clock signals VCK1 to VCK8 is fixed. For example, a gap GAP1 between the first enable signal and the second enable signal of the voltage control clock signal VCK1 is 8 scan time periods, and a gap GAP2 between the second enable signal and the next enable signal of the voltage control clock signal VCK1 is 6 scan time periods. A sum of the gap GAP1 and the gap GAP2 is a fixed value (i.e., 2P−2). Persons applying this embodiment may adjust P (the number of voltage control clock signals) and Y (an interval count of driving the scan lines of the GOA driver) according to the requirements (for example, Y, the interval count of driving scan lines in the embodiments of FIG. 4 and FIG. 5A to FIG. 5B, is 2 (also referred to as GN+−2 driving manner)), and thus change the values of the gap GAP1 and the gap GAP2, as exemplified in Table (2):

TABLE 2

| | Y (interval count of | | |
|---|---|---|---|
| | driving scan lines in | | |
| P (number of VCK) | hardware structure) | GAP1 | GAP2 |
| 4 | 1 | 2 | 4 |
| | | 4 | 2 |
| 8 | 1 | 2 | 12 |
| | | 4 | 10 |
| | | 6 | 8 |
| | | 8 | 6 |
| | | 10 | 4 |
| | | 12 | 2 |
| 8 | 2 | 4 | 10 |
| | | 6 | 8 |
| | | 8 | 6 |
| | | 10 | 4 |

Table (3) presents examples that may be implemented corresponding to P (the number of voltage control clock signals VCK1 to VCKP) and Y (the interval count of driving scan lines in the hardware structure of the GOA driver that persons applying this embodiment May implement.

TABLE 3

| | Y (interval count of driving | |
|---|---|---|
| P (number | scan lines in hardware | whether to be |
| of VCK) | structure) | implemented |
| 4 | 1 | Yes |
| 8 | 1 | Yes |
| 8 | 2 | Yes |
| 16 | 1 | Yes |
| 16 | 2 | Yes |
| 16 | 4 | Yes |

The embodiments of FIG. 4 and FIG. 5A to FIG. 5B are examples where P is 8, and Y is 2 (also referred to as GN+−2 driving manner) in Table (3).

FIG. 6 is a schematic diagram illustrating a detailed structure of a gate driver on array according to a second embodiment of the disclosure. The EPD panel 110 with the resolution of 1920×1440 is taken as an example in FIG. 6. The GOA driver 130 in FIG. 2 may include 720 (i.e., N/2) first gate selection circuits 410-1 to 410-720, 720 (i.e., N/2) second gate selection circuits 420-1 to 420-720, 720 (i.e., N/2) third gate selection circuits 530-1 to 530-720, and 720 (i. e., N/2) fourth gate selection circuits 540-1 to 540-720 in FIG. 6. The third gate selection circuits 530-1 to 530-720 and the fourth gate selection circuits 540-1 to 540-720 may respectively be GOA stage circuits.

The first gate selection circuits 410-1 to 410-720 and the second gate selection circuits 420-1 to 420-720 are disposed on the first side of the EPD panel 110 (for example, the left side of FIG. 4). The third gate selection circuits 530-1 to 530-720 and the fourth gate selection circuits 540-1 to 540-720 are disposed on the second side of the EPD panel 110 (for example, the right side of FIG. 4). Each of the first gate selection circuits 410-1 to 410-720 and the third gate selection circuits 530-1 to 530-720 are respectively coupled to one of the odd-numbered scan lines among the 1440 scan lines. Each of the second gate selection circuits 420-1 to 420-720 and the fourth gate selection circuits 540-1 to 540-720 are respectively coupled to one of the even-numbered scan lines among the 1440 scan lines.

The first gate selection circuits 410-1 to 410-720 and the third gate selection circuits 530-1 to 530-720 are controlled by the enable signal STV1, the voltage control clock signals VCK1, VCK3, VCK5, VCK7, and the reset signal RST1. The second gate selection circuits 420-1 to 420-720 and the fourth gate selection circuits 540-1 to 540-720 are controlled by the enable signal STV2, the voltage control clock signals VCK2, VCK4, VCK6, VCK8, and the reset signal RST2.

A structure of the GOA driver circuit shown in FIG. 6 may be referred to as a dual-side input gate array circuit architecture. Each of the scan lines G1 to G1440 is respectively driven by two gate selection circuits to enhance the driving of the scan lines G1 to G1440. Signal waveforms of FIG. 5A to FIG. 5B may also be applied to FIG. 6. The embodiment of FIG. 6 is also an example where P is 8, and Y is 2 (also referred to as GN+−2 driving manner) in Table (3).

FIG. 7 is a schematic diagram illustrating a detailed structure of a gate driver on array according to a third embodiment of the disclosure. The EPD panel 110 with the resolution of 1920×1440 is taken as an example in FIG. 7. The GOA driver 130 in FIG. 2 may include 1440 (i.e., N) first gate selection circuits 710-1 to 710-1440 and 1440 (i.e., N) second gate selection circuits 720-1 to 720-1440 in FIG. 7. The first gate selection circuits 710-1 to 710-1440 and the second gate selection circuits 720-1 to 720-1440 may respectively be GOA stage circuits.

The first gate selection circuits 710-1 to 710-1440 are disposed on the first side of the EPD panel 110 (for example, the left side of FIG. 7). The second gate selection circuits 720-1 to 720-1440 are disposed on the second side of the EPD panel 110 (for example, the right side of FIG. 7). Each of the first gate selection circuits 710-1 to 710-1440 and the second gate selection circuits 720-1 to 720-1440 respectively are coupled to one of the 1440 scan lines. The first gate selection circuits 710-1 to 710-1440 and the second gate selection circuits 720-1 to 720-1440 are controlled by the enable signal STV1, the voltage control clock signals VCK1 to VCKP, and the reset signal RST1. According to the aforementioned embodiments, and the “across interlaced scan” in FIG. 2 may be implemented. The embodiment of FIG. 7 is an example where P is 4, and Y is 1 (also referred to as GN+−1 driving manner) in Table (3).

Table (4) is a comparison of the corresponding circuit structures of the aforementioned FIG. 4, FIG. 6, and FIG. 7, as an example for description.

TABLE 4

| | Circuit | Circuit | Circuit |
|---|---|---|---|
| | structure in | structure in | structure in |
| | FIG. 4 | FIG. 6 | FIG. 7 |
| Structure | Single-sided | Dual-sided | Dual-sided |
| | input/ | input | input |
| | interlaced | | |
| Gate driver | 2 sets of | 2 sets of | 1 set of |
| on array | gate driver | gate driver | gate driver |
| | on array | on array | on array |
| | circuits | circuits | circuits |
| Interval count Y | GN+-2 | GN+-2 | GN+-1 |
| (driving manner) of | | | |
| driving scan lines | | | |
| P (number of VCK) | 4 | 8 | 8 |

In summary, the embodiments of the disclosure perform frame scan and update on the EPD device through interlaced scan across a fixed number of scan lines, and the number of scan lines across by this interlaced scan may be adjusted according to the requirements. For example, the interlaced scan may be performed with the gap of approximately one-fourth of the scan lines of the display panel. If the display panel has 1440 scan lines, the interlaced scan may be performed with the gap of 360 scan lines or 1080 scan lines. In the embodiments of the disclosure, the GOA circuit architecture is used to implement the aforementioned interlaced scan, which may reduce the flicker of the EPD device when frames are switched.

What is claimed is:

1. A driving method of an electronic paper display device, wherein the electronic paper display device comprises an electronic paper display panel and a gate driver on array, wherein the electronic paper display panel and the gate driver on array of the electronic paper display device are disposed on an electronic paper display substrate, the electronic paper display panel comprises N scan lines, and the N is a positive integer and an even number,
the driving method comprising:
based on controlling the gate driver on array, performing an interlaced scan across K scan lines for the N scan lines on the electronic paper display panel,
wherein the step of the interlaced scan across the K scan lines comprises:
scanning an Xth scan line, and scanning an (X+K)th scan line, wherein the X is a positive integer sequentially increasing, and 1≤X≤N.

2. The driving method of the electronic paper display device according to claim 1, wherein
when an (X+K) is greater than the N, scanning the (X+K)th scan line is changed to scanning an (X+K−N)th scan line; and
when an (X+1) is greater than the N, scanning an (X+1)th scan line is changed to scanning an (X+1−N)th scan line.

3. The driving method of the electronic paper display device according to claim 1, wherein the interlaced scan across the K scan lines divides time for scanning a frame of the electronic paper display panel into 2N scan time periods.

4. The driving method of the electronic paper display device according to claim 1, wherein the K is N/4, N/3, or 3N/4.

5. The driving method of the electronic paper display device according to claim 1, wherein the gate driver on array is controlled by P voltage control clock signals, a time which each of the voltage control clock signals is enabled in the same cycle is Z, and time for scanning a frame of the electronic paper display panel is divided into 2N/2P cycles, P and M are positive integers, and Z multiplied by P equals M;
each of the voltage control clock signals is enabled one time during one of odd-numbered scan time periods, and each of the voltage control clock signal is enabled another time during one of even-numbered scan time periods; and
in each cycle, a gap between enable signals of each of the voltage control clock signals is fixed.

6. The driving method of the electronic paper display device according to claim 1, wherein the gate driver on array comprises:
N/2 first gate selection circuits, each of the first gate selection circuits being respectively coupled to one of odd-numbered scan lines among the N scan lines, and the first gate selection circuits being controlled by a first enable signal; and
N/2 second gate selection circuits, each of the second gate selection circuits being respectively coupled to one of even-numbered scan lines among the N scan lines, and the second gate selection circuits being controlled by a second enable signal.

7. The driving method of the electronic paper display device according to claim 6, wherein the gate driver on array further comprises:
N/2 third gate selection circuits, each of the third gate selection circuits being respectively coupled to one of odd-numbered scan lines, and the third gate selection circuits being controlled by the first enable signal; and
N/2 fourth gate selection circuits, each of the fourth gate selection circuits being respectively coupled to one of even-numbered scan lines, and the fourth gate selection circuits being controlled by the second enable signal.

8. The driving method of the electronic paper display device according to claim 1, wherein the gate driver on array comprises:
N first gate selection circuits, each of the first gate selection circuits being respectively coupled to one of the N scan lines; and
N second gate selection circuits, each of the second gate selection circuits being respectively coupled to one of the N scan lines, and the first gate selection circuits and the second gate selection circuits being controlled by a first enable signal.

9. An electronic paper display device, comprising:
an electronic paper display panel, comprising N scan lines;
a display controller; and
a gate driver on array, coupled to the display controller and the electronic paper display panel, wherein the electronic paper display panel and the gate driver on array are disposed on an electronic paper display substrate,
wherein the display controller controls the gate driver on array to perform an interlaced scan across K scan lines on the electronic paper display panel, and where K is a positive integer less than N.

10. The electronic paper display device according to claim 9, wherein the display controller controls the gate driver on array to:
scan an Xth scan line, and scan an (X+K)th scan line, wherein the X is a sequentially increasing positive integer, and 1≤X≤N.

11. The electronic paper display device according to claim 9, wherein,
when an (X+K) is greater than the N, scanning an (X+K)th scan line is changed to scanning an (X+K−N)th scan line, and
when an (X+1) is greater than the N, scanning an (X+1)th scan line is changed to scanning an (X+1−N)th scan line.

12. The electronic paper display device according to claim 9, wherein the interlaced scan across the K scan lines divides time for scanning a frame of the electronic paper display panel into 2N scan time periods.

13. The electronic paper display device according to claim 9, wherein the K is N/4, N/3, or 3N/4.

14. The electronic paper display device according to claim 9, wherein the gate driver on array is controlled by P voltage control clock signals, a time which each voltage control clock signal is enabled in the same cycle is Z, and time for scanning a frame of the electronic paper display panel is divided into 2N/2P cycles, P and M are positive integers, and Z multiplied by P equals M;
each of the voltage control clock signals is enabled one time during one of an odd-numbered scan time periods, and each of the voltage control clock signals is enabled another time during one of an even-numbered scan time periods; and
in each cycle, a gap between enable signals of each of the voltage control clock signals is fixed.

15. The electronic paper display device according to claim 9, wherein the gate driver on array comprises:
N/2 first gate selection circuits, each of the first gate selection circuits being respectively coupled to one of odd-numbered scan lines among the N scan lines, and the first gate selection circuits being controlled by a first enable signal; and
N/2 second gate selection circuits, each of the second gate selection circuits being respectively coupled to one of even-numbered scan lines among the N scan lines, and the second gate selection circuits being controlled by a second enable signal.

16. The electronic paper display device according to claim 15, wherein the gate driver on array further comprises:
N/2 third gate selection circuits, each of the third gate selection circuits being respectively coupled to one of odd-numbered scan lines, and the third gate selection circuits being controlled by the first enable signal; and
N/2 fourth gate selection circuits, each of the fourth gate selection circuits being respectively coupled to one of even-numbered scan lines, and the fourth gate selection circuits being controlled by the second enable signal.

17. The electronic paper display device according to claim 9, wherein the gate driver on array comprises:
N first gate selection circuits, each of the first gate selection circuits being respectively coupled to one of the N scan lines; and
N second gate selection circuits, each of the second gate selection circuits being respectively coupled to one of the N scan lines, and the first gate selection circuits and the second gate selection circuits being controlled by a first enable signal.
